(19) United States
(12) Patent Application Publication
(10) Pub. No.: US 2026/0298971 A1
(43) Pub. Date: Oct. 1, 2026

(54) Vibration Rectification Error Correction Device And Sensor Module

(71) Applicant: SEIKO EPSON CORPORATION, Tokyo (JP)

(72) Inventor: Masayoshi TODOROKIHARA, Suwa (JP)

(21) Appl. No.: 19/631,007

(22) Filed: Mar. 27, 2026

(30) Foreign Application Priority Data
Mar. 28, 2025 (JP) 2025-055270

(51) Int. Cl. G01P 15/18

(52) U.S. Cl. CPC G01P 15/18

(57) ABSTRACT

Provided is a vibration rectification error correction device including: a reference signal generation circuit configured to output a reference signal; a frequency delta-sigma modulation unit configured to perform frequency delta-sigma modulation on the reference signal using a measurement signal to generate a frequency delta-sigma modulation signal; a first processing unit configured to operate in synchronization with the measurement signal, perform processing of applying a first group delay amount and first filter processing on the frequency delta-sigma modulation signal, and output a first signal; and a second processing unit configured to operate in synchronization with the reference signal, perform processing of applying a second group delay amount and second filter processing on the first signal independently of each other, and output a second signal, in which the first group delay amount and the second group delay amount are variable independently of each other.

The present application is based on, and claims priority from JP Application Serial Number 2025-055270, filed Mar. 28, 2025, the disclosure of which is hereby incorporated by reference herein in its entirety.

### BACKGROUND

### 1. Technical Field

The present disclosure relates to a vibration rectification error correction device and a sensor module.

### 2. Related Art

JP-A-2019-190897 discloses a physical quantity sensor module including a physical quantity sensor, a reference signal oscillation unit that outputs a reference signal, a frequency delta-sigma modulation unit that generates a frequency delta-sigma modulation signal by performing frequency delta-sigma modulation on the reference signal using an operation signal based on a measurement signal that is an output of the physical quantity sensor, a first low-pass filter that is provided on an output side of the frequency delta-sigma modulation unit and operates in synchronization with the measurement signal, and a second low-pass filter that is provided on an output side of the first low-pass filter and operates in synchronization with the reference signal. According to the physical quantity sensor module disclosed in JP-A-2019-190897, it is possible to correct non-linearity of an output signal of the physical quantity sensor without increasing a size thereof.

JP-A-2019-190897 is an example of the related art.

In the physical quantity sensor module disclosed in JP-A-2019-190897, a vibration rectification error caused by non-linearity of an input and an output of the entire low-pass filter is corrected by adjusting a group delay amount of the first low-pass filter, but a group delay time changes according to a correction amount of the vibration rectification error. Therefore, for example, when the physical quantity sensor module includes a plurality of physical quantity sensors, a difference occurs in an acquisition timing of a measurement value based on the output signal of each of the plurality of physical quantity sensors.

### SUMMARY

A vibration rectification error correction device according to one aspect of the present disclosure includes:
a reference signal generation circuit configured to output a reference signal;
a frequency delta-sigma modulation unit configured to perform frequency delta-sigma modulation on the reference signal using a measurement signal to generate a frequency delta-sigma modulation signal;
a first processing unit configured to operate in synchronization with the measurement signal, perform processing of applying a first group delay amount and first filter processing on the frequency delta-sigma modulation signal, and output a first signal; and
a second processing unit configured to operate in synchronization with the reference signal, perform processing of applying a second group delay amount and second filter processing on the first signal independently of each other, and output a second signal, in which
the first group delay amount and the second group delay amount are variable independently of each other.

A sensor module according to one aspect of the present disclosure includes:
a plurality of physical quantity sensors; and
a vibration rectification error correction device, in which
the vibration rectification error correction device includes
   a reference signal generation circuit configured to output a reference signal, and
   a plurality of frequency ratio measurement circuits,
a plurality of measurement signals based on output signals of the plurality of physical quantity sensors are input to the plurality of frequency ratio measurement circuits, respectively,
each of the plurality of frequency ratio measurement circuits includes
   a frequency delta-sigma modulation unit configured to perform frequency delta-sigma modulation on the reference signal using the input measurement signal to generate a frequency delta-sigma modulation signal,
   a first processing unit configured to operate in synchronization with the measurement signal, perform processing of applying a first group delay amount and first filter processing on the frequency delta-sigma modulation signal, and output a first signal, and
   a second processing unit configured to operate in synchronization with the reference signal, perform processing of applying a second group delay amount and second filter processing on the first signal independently of each other, and output a second signal,
the first group delay amount and the second group delay amount are variable independently of each other, and
the second group delay amount of each of the plurality of frequency ratio measurement circuits is set such that group delay times from when the measurement signal is input to when the second signal is output coincide with each other among the plurality of frequency ratio measurement circuits.

### BRIEF DESCRIPTION OF THE DRAWINGS

FIG. 1 is a perspective view of a sensor module.

FIG. 2 is an exploded perspective view of the sensor module.

FIG. 3 is a perspective view of a physical quantity sensor.

FIG. 4 is a plan view of the physical quantity sensor.

FIG. 5 is a cross-sectional view taken along a line P1-P1 in FIG. 4.

FIG. 6 is a view of an operation of the physical quantity sensor.

FIG. 7 is a view of an operation of the physical quantity sensor.

FIG. 8 is a functional block diagram of the sensor module according to a first embodiment.

FIG. 9 is a diagram illustrating in principle that a vibration rectification error occurs due to an output waveform distortion.

FIG. 10 is a diagram illustrating non-linearity between an applied acceleration and a reciprocal count value.

FIG. 11 is a diagram illustrating non-linearity between the applied acceleration and an oscillation frequency of the physical quantity sensor.

FIG. 12 is a diagram illustrating non-linearity between the oscillation frequency and the reciprocal count value of the physical quantity sensor.

FIG. 13 is a diagram illustrating a configuration example of a frequency ratio measurement circuit.

FIG. 14 is a diagram illustrating a configuration example of a frequency delta-sigma modulation unit.

FIG. 15 is a diagram illustrating a configuration example of a first processing unit.

FIG. 16 is a diagram illustrating a configuration example of a second processing unit.

FIG. 17 is a diagram illustrating a relationship between each block of the frequency ratio measurement circuit and a group delay time.

FIG. 18 is a functional block diagram of a sensor module according to a second embodiment.

FIG. 19 is a diagram illustrating a configuration example of a sensing system.

### DESCRIPTION OF EMBODIMENTS

Preferred embodiments according to the present disclosure will hereinafter be described in detail using the drawings. The embodiments to be described below do not unduly limit the content of the present disclosure described in the claims. In addition, not all configurations described below are necessarily essential component elements of the present disclosure.

### 1. First Embodiment

### 1-1. Structure of Sensor Module

First, an example of a structure of a sensor module according to the embodiment will be described.

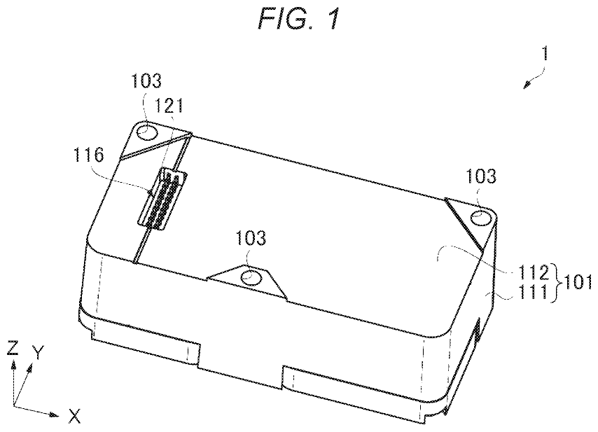

FIG. 1 is a perspective view of a sensor module 1 when viewed from a mounting surface side to which the sensor module 1 is fixed. In the following description, a direction along a long side of the sensor module 1 having a rectangular shape in a plan view is referred to as an X-axis direction, a direction orthogonal to the X-axis direction in the plan view is referred to as a Y-axis direction, and a thickness direction of the sensor module 1 is referred to as a Z-axis direction.

The sensor module 1 is a rectangular parallelepiped having a rectangular planar shape, and has long sides along the X-axis direction and short sides along the Y-axis direction orthogonal to the X-axis direction. Screw holes 103 are formed at two positions near both end portions of one long side and at one position in a central portion of the other long side. The sensor module 1 is used in a state of being fixed to a mounting surface of a mounting body, such as a building, a bulletin board, or various devices, by passing a fixing screw through each of the three screw holes 103.

As illustrated in FIG. 1, an opening portion 121 is provided in a surface of the sensor module 1 as viewed from the mounting surface side. A plug type connector 116 is disposed inside the opening portion 121. The connector 116 includes a plurality of pins arranged in two rows, and the plurality of pins are arranged in the Y-axis direction in each row. A socket type connector (not illustrated) is coupled to the connector 116 from the mounting body, and electric signals, such as a drive voltage of the sensor module 1 and detection data, are transmitted and received.

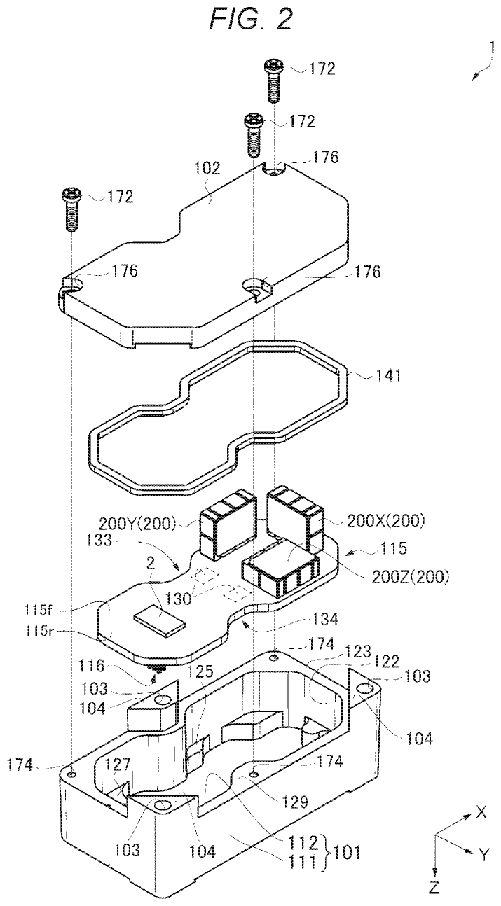

FIG. 2 is an exploded perspective view of the sensor module 1. As illustrated in FIG. 2, the sensor module 1 includes a container 101, a lid 102, a seal member 141, and a circuit board 115. More specifically, the sensor module 1 has a configuration in which the circuit board 115 is attached to an inside of the container 101 with fixing members 130 interposed therebetween, and an opening of the container 101 is covered with the lid 102 via the seal member 141 having a cushioning property.

The container 101 is formed of, for example, aluminum and is a box-shaped container for housing the circuit board 115, which has an internal space. Similarly to the overall shape of the sensor module 1 described above, an outer shape of the container 101 is a rectangular parallelepiped having a substantially rectangular planar shape. Fixing protrusions 104 are provided at two positions near both end portions of one long side and at one position in a central portion of the other long side. The screw hole 103 is formed in each of the fixing protrusions 104.

The container 101 has a rectangular parallelepiped outer shape and a box shape that is open on one side. An interior of the container 101 is an internal space surrounded by a bottom wall 112 and a side wall 111. In other words, the container 101 has a box shape in which one surface facing the bottom wall 112 is an opening surface 123, an outer edge of the circuit board 115 is disposed along an inner surface 122 of the side wall 111, and the lid 102 is fixed to cover the opening. On the opening surface 123, the fixing protrusions 104 are erected at two positions near both end portions of one long side and one place in the central portion of the other long side of the container 101. An upper surface of the fixing protrusion 104, that is, a surface exposed in a −Z axis direction of the fixing protrusion 104 protrudes from an upper surface of the container 101.

A protrusion 129, which is a central portion of one long side facing the fixing protrusion 104 provided at the central portion of the other long side and protrudes from the side wall 111 toward an internal space side from the bottom wall 112 to the opening surface 123, is provided in the internal space of the container 101. A female screw 174 is provided on an upper surface of the protrusion 129. The lid 102 is fixed to the container 101 via the seal member 141 by screws 172 inserted into through holes 176 and the female screw 174. The protrusion 129 and the fixing protrusions 104 are provided at positions facing waist portions 133 and 134 of the circuit board 115 to be described later.

In the internal space of the container 101, a first pedestal 127 and a second pedestal 125 that protrude in a stepped manner, from the bottom wall 112 toward an opening surface 123 side are provided. The first pedestal 127 is provided at a position facing an arrangement region of the plug type connector 116 attached to the circuit board 115. The first pedestal 127 is provided with the opening portion 121 illustrated in FIG. 1, and the plug type connector 116 is inserted into the opening portion 121. The first pedestal 127 functions as a pedestal for fixing the circuit board 115 to the container 101.

The second pedestal 125 is located on a side opposite to the first pedestal 127 with respect to the fixing protrusion 104 and the protrusion 129, which are located at the central portions of the long sides, and is provided near the fixing protrusion 104 and the protrusion 129. The second pedestal 125 functions as a pedestal for fixing the circuit board 115 to the container 101 on the side opposite to the first pedestal 127 with respect to the fixing protrusion 104 and the protrusion 129.

The outer shape of the container 101 is described as a rectangular parallelepiped having a substantially rectangular planar shape and a box shape without a lid, but a planar shape of the outer shape of the container 101 is not limited thereto, and may be square, hexagonal, or octagonal. In the planar shape of the outer shape of the container 101, corners of vertex portions of the polygon may be chamfered, and any of edges may be formed by a curved line in the planar shape. The planar shape of the interior of the container 101 is not limited to the above-described shape, and may be another shape. The planar shapes of the outer shape and the interior of the container 101 may be similar to each other or may not be similar to each other.

The circuit board 115 is a multilayer substrate in which a plurality of through holes are formed, and for example, a glass epoxy substrate, a composite substrate, or a ceramic substrate is used.

The circuit board 115 has a second surface 115r on a bottom wall 112 side and a first surface 115f that has a front and back relationship with the second surface 115r. A vibration rectification error correction device 2, three physical quantity sensors 200, and other electronic components (not illustrated) are mounted on the first surface 115f of the circuit board 115. The connector 116 is mounted on the second surface 115r of the circuit board 115. Although illustration and description thereof are omitted, other wirings, terminal electrodes, and the like may be provided on the circuit board 115.

The circuit board 115 includes the waist portions 133 and 134 in which the outer edge of the circuit board 115 is constricted at the central portions in the X-axis direction along the long sides of the container 101 in the plan view. The waist portions 133 and 134 are provided on both sides of the circuit board 115 in the Y-axis direction in the plan view, and are constricted from the outer edge toward a center of the circuit board 115. The waist portions 133 and 134 are provided to face the protrusion 129 and the fixing protrusion 104 of the container 101.

The circuit board 115 is inserted into the internal space of the container 101 with the second surface 115r facing the first pedestal 127 and the second pedestal 125. The circuit board 115 is supported on the container 101 by the first pedestal 127 and the second pedestal 125.

Each of the three physical quantity sensors 200 is a frequency change type sensor in which a frequency of an output signal changes according to an applied physical quantity. Among the three physical quantity sensors 200, a physical quantity sensor 200X detects a physical quantity in the X-axis direction, a physical quantity sensor 200Y detects a physical quantity in the Y-axis direction, and the physical quantity sensor 200Z detects a physical quantity in the Z-axis direction. Specifically, the physical quantity sensor 200X is erected such that front and back surfaces of a package face in the X-axis direction and a side surface faces the first surface 115f of the circuit board 115. The physical quantity sensor 200X outputs a signal corresponding to the detected physical quantity in the X-axis direction. The physical quantity sensor 200Y is erected such that front and back surfaces of a package face in the Y-axis direction and a side surface faces the first surface 115f of the circuit board 115. The physical quantity sensor 200Y outputs a signal corresponding to the detected physical quantity in the Y-axis direction. The physical quantity sensor 200Z is provided such that front and back surfaces of a package face in the Z-axis direction, that is, the front and back surfaces of the package directly face the first surface 115f of the circuit board 115. The physical quantity sensor 200Z outputs a signal corresponding to the detected physical quantity in the Z-axis direction.

The vibration rectification error correction device 2 is electrically coupled to the physical quantity sensors 200X, 200Y, and 200Z via wirings or electronic components (not illustrated). The vibration rectification error correction device 2 generates physical quantity data in which a vibration rectification error is reduced based on output signals of the physical quantity sensors 200X, 200Y, and 200Z.

### 1-2. Structure of Physical Quantity Sensor

Next, an example of a structure of the physical quantity sensor 200 will be described by taking a case where the physical quantity sensor 200 is an acceleration sensor as an example. The three physical quantity sensors 200 illustrated in FIG. 2, that is, the physical quantity sensors 200X, 200Y, and 200Z may have the same structure.

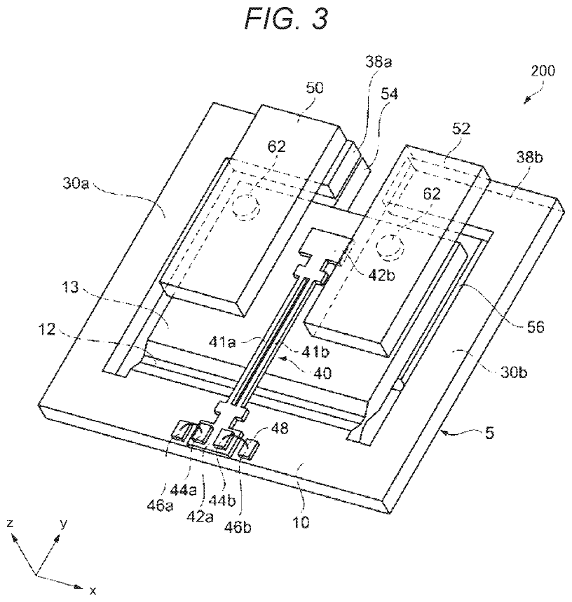

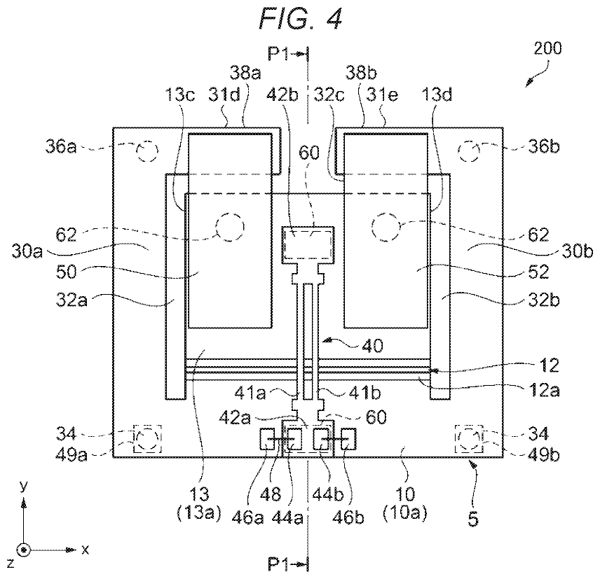

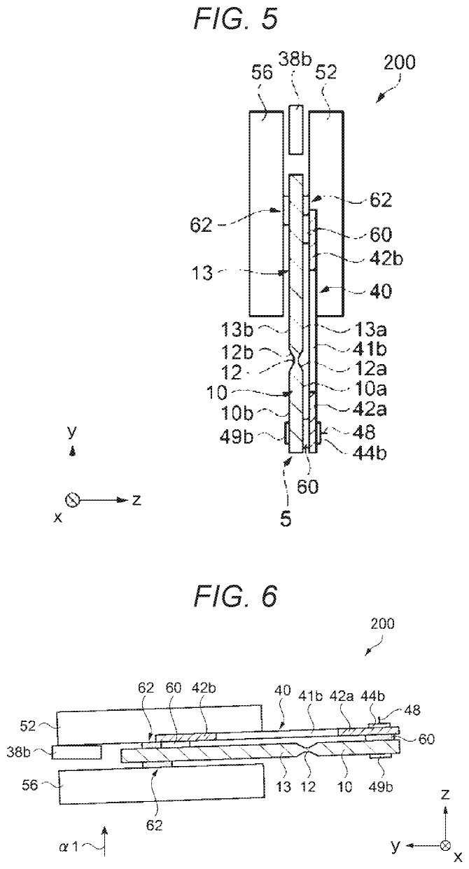

FIG. 3 is a perspective view of the physical quantity sensor 200. FIG. 4 is a plan view of the physical quantity sensor 200. FIG. 5 is a cross-sectional view taken along a line P1-P1 in FIG. 4. FIGS. 3 to 5 illustrate only an interior of the package of the physical quantity sensor 200. For convenience of description, an X axis, a Y axis, and a Z axis are illustrated as three axes orthogonal to each other in the drawings. For convenience of description, a plan view viewed from the Z-axis direction, which is a thickness direction of extend portions 38a and 38b, is also referred to simply as a “plan view” in the following description.

As illustrated in FIGS. 3 to 5, the physical quantity sensor 200 includes a substrate portion 5 and four weights 50, 52, 54, and 56.

The substrate portion 5 includes a plate-shaped base 10 having main surfaces 10a and 10b extending in the x-axis direction and facing opposite to each other, a joint portion 12 extending from the base 10 in the y-axis direction, a movable portion 13 extending from the joint portion 12 in a rectangular shape in a direction opposite to the base 10, two support portions 30a and 30b extending from both ends of the base 10 in the x-axis direction along an outer edge of the movable portion 13, and a physical quantity detection element 40 bridged from the base 10 to the movable portion 13 and bonded to the base 10 and the movable portion 13.

In the two support portions 30a and 30b, the support portion 30a extends along the y axis with a gap 32a from the movable portion 13, and is provided with a bonding portion 36a fixing the support portion 30a and an extend portion 38a extending along the x axis with a gap 32c from the movable portion 13. In other words, the support portion 30a extends along the y axis with the gap 32a from the movable portion 13, is provided with the extend portion 38a extending along the x axis with the gap 32c from the movable portion 13, and is provided with the bonding portion 36a at a portion from the support portion 30a to the extend portion 38a. The support portion 30b extends along the y axis with a gap 32b from the movable portion 13, and is provided with a bonding portion 36b fixing the support portion 30b and an extend portion 38b extending along the x axis with the gap 32c from the movable portion 13. In other words, the support portion 30b extends along the y axis with the gap 32b from the movable portion 13, is provided with the extend portion 38b extending along the x axis with the gap 32c from the movable portion 13, and is provided with the bonding portion 36b at a portion from the support portion 30b to the extend portion 38b.

The bonding portions 36a and 36b provided in the support portions 30a and 30b are used for mounting the substrate portion 5 of the physical quantity sensor 200 on an external member, such as a package. The base 10, the joint portion 12, the movable portion 13, the support portions 30a and 30b, and the extend portions 38a and 38b may be integrally formed.

The movable portion 13 is surrounded by the support portions 30a and 30b and the base 10, and is coupled to the base 10 via the joint portion 12, being in a cantilevered supported state. The movable portion 13 has main surfaces 13a and 13b facing opposite to each other, a side surface 13c along the support portion 30a, and a side surface 13d along the support portion 30b. The main surface 13a faces the same side as the main surface 10a of the base 10, and the main surface 13b faces the same side as the main surface 10b of the base 10.

The joint portion 12 is provided between the base 10 and the movable portion 13, and couples the base 10 and the movable portion 13. The joint portion 12 is formed to have a thickness less than a thickness of the base 10 and a thickness of the movable portion 13. The joint portion 12 has grooves 12a and 12b. The grooves 12a and 12b are formed along the X axis, and when the movable portion 13 is displaced with respect to the base 10, the grooves 12a and 12b in the joint portion 12 function as fulcrums, that is, as intermediate hinges. Such a joint portion 12 and such a movable portion 13 function as a cantilever.

To a surface continuing from the main surface 10a of the base 10 to the main surface 13a of the movable portion 13, the physical quantity detection element 40 is fixed with a bonding material 60. Fixing positions of the physical quantity detection element 40 are two positions at center positions of the main surface 10a and the main surface 13a in the x-axis direction.

The physical quantity detection element 40 includes a base portion 42a fixed to the main surface 10a of the base 10 with the bonding material 60, a base portion 42b fixed to the main surface 13a of the movable portion 13 with the bonding material 60, and vibration beams 41a and 41b disposed between the base portion 42a and the base portion 42b for detecting a physical quantity. In this case, a shape of each of the vibration beams 41a and 41b is prismatic, and when a drive signal of an AC voltage is applied to excitation electrodes (not illustrated) provided on the vibration beams 41a and 41b, the vibration beams 41a and 41b perform flexural vibration along the x axis, moving away from or towards each other. That is, the physical quantity detection element 40 is a tuning fork type vibrator element.

Extraction electrodes 44a and 44b are provided on the base portion 42a of the physical quantity detection element 40. The extraction electrodes 44a and 44b are electrically coupled to the excitation electrodes (not illustrated) provided on the vibration beams 41a and 41b. The extraction electrodes 44a and 44b are electrically coupled to connection terminals 46a and 46b provided on the main surface 10a of the base 10 by metal wires 48. The connection terminals 46a and 46b are electrically coupled to external connection terminals 49a and 49b by wirings (not illustrated). The external connection terminals 49a and 49b are provided on a main surface 10b side of the base 10, which is a surface on which the physical quantity sensor 200 is mounted on a package or the like, to overlap package bonding portions 34 in the plan view. The package bonding portions 34 are for mounting the substrate portion 5 of the physical quantity sensor 200 on an external member such as a package, and are disposed at two position at end portions on both end sides of the base 10 in the X-axis direction.

The physical quantity detection element 40 is formed by patterning a crystal substrate that is carved out from a crystal stone at a predetermined angle, using a photolithography technique and an etching technique. In this case, it is desirable for the physical quantity detection element 40 to be provided with the same material as materials of the base 10 and the movable portion 13, taking a reduction of a difference in linear expansion coefficient between the physical quantity detection element 40 and the base 10 and the movable portion 13 into consideration.

The weights 50, 52, 54, and 56 have a rectangular shape in the plan view and are provided on the movable portion 13. The weights 50 and 52 are fixed to the main surface 13a of the movable portion 13 by a bonding member 62, and the weights 54 and 56 are fixed to the main surface 13b of the movable portion 13 by the bonding member 62. Here, in the weight 50 fixed to the main surface 13a, in the plan view, one side that is an edge of the rectangle is aligned with the side surface 13c of the movable portion 13, and the other side is aligned with a side surface 31d of the extend portion 38a. By aligning the directions in this way, the weight 50 is disposed on a side surface 13c side of the movable portion 13, and the weight 50 and the extend portion 38a are disposed to overlap each other in the plan view. Similarly, in the weight 52 fixed to the main surface 13a, in the plan view, one side that is an edge of the rectangle is aligned with the side surface 13d of the movable portion 13, and the other side is aligned with a side surface 31e of the extend portion 38b. Accordingly, the weight 52 is disposed on a side surface 13d side of the movable portion 13, and the weight 52 and the extend portion 38b are disposed to overlap each other in the plan view. In the weight 54 fixed to the main surface 13b, in the plan view, one side of the rectangle is aligned with the side surface 13c of the movable portion 13, and the other side is aligned with the side surface 31d of the extend portion 38a. Accordingly, the weight 54 is disposed on the side surface 13c side of the movable portion 13, and the weight 54 and the extend portion 38a are disposed to overlap each other in the plan view. Similarly, in the weight 56 fixed to the main surface 13b, in the plan view, one side of the rectangle is aligned with the side surface 13d of the movable portion 13, and the other side is aligned with the side surface 31e of the extend portion 38b. Accordingly, the weight 56 is disposed on the side surface 13d side of the movable portion 13, and the weight 56 and the extend portion 38b are disposed to overlap each other in the plan view.

In the weights 50, 52, 54, and 56 disposed in this way, the weights 50 and 52 are disposed symmetrically with respect to the physical quantity detection element 40, and the weights 54 and 56 are disposed to overlap the weights 50 and 52 in the plan view, respectively. The weights 50, 52, 54, and 56 are fixed to the movable portion 13 by the bonding members 62 provided at positions of center of gravity of the weights 50, 52, 54, and 56. Since the weights 50 and 54 and the extend portion 38a overlap, and the weights 52 and 56 and the extend portion 38b overlap in the plan view, when an excessive physical quantity is applied, the weights 50, 52, 54, and 56 comes into contact with the extend portions 38a and 38b, and displacement amounts of the weights 50, 52, 54, and 56 can be prevented.

The bonding members 62 are each formed of a silicone resin-based thermosetting adhesive or the like. The bonding members 62 are applied at two positions of each of the main surface 13a and the main surface 13b of the movable portion 13, and then the weights 50, 52, 54, and 56 are placed, heated, and cured to fix the weights 50, 52, 54, and 56 to the movable portion 13. Bonding surfaces of the weights 50, 52, 54, and 56 facing the main surface 13a and the main surface 13b of the movable portion 13 are rough surfaces. Accordingly, when fixing the weights 50, 52, 54, and 56 to the movable portion 13, a bonding area in each of the bonding surfaces increases, and a bonding strength can be increased.

As illustrated in FIG. 6, when an acceleration in a +Z-axis direction represented by an arrow α1 is applied to the physical quantity sensor 200 implemented as described above, a force acts on the movable portion 13 in a −Z-axis direction, and the movable portion 13 is displaced in the −Z-axis direction with the joint portion 12 as a fulcrum. Accordingly, a force in a direction in which the base portion 42a and the base portion 42b are separated from each other along the Y axis is applied to the physical quantity detection element 40, and a tensile stress occurs in the vibration beams 41a and 41b. Therefore, a frequency at which the vibration beams 41a and 41b vibrate increases.

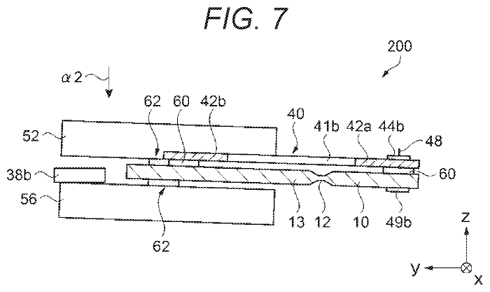

In contrast, as illustrated in FIG. 7, when an acceleration in the −Z-axis direction represented by an arrow α2 is applied to the physical quantity sensor 200, a force acts on the movable portion 13 in the +Z-axis direction, and the movable portion 13 is displaced in the +Z-axis direction with the joint portion 12 as a fulcrum. Accordingly, a force in a direction in which the base portion 42a and the base portion 42b approach each other along the Y axis is applied to the physical quantity detection element 40, and a compressive stress occurs in the vibration beams 41a and 41b. Therefore, the frequency at which the vibration beams 41a and 41b vibrate decreases.

When the frequency at which the vibration beams 41a and 41b vibrate changes according to the acceleration, a frequency of a signal output from the external connection terminals 49a and 49b of the physical quantity sensor 200 changes. The sensor module 1 can calculate a value of the acceleration applied to the physical quantity sensor 200 based on a change in the frequency of the output signal of the physical quantity sensor 200.

To improve a detection accuracy of the acceleration which is a physical quantity, it is desirable that the joint portion 12 connecting the base 10, which is a fixed portion, and the movable portion 13 is quartz crystal, which is a member having a high Q value. For example, the base 10, the support portions 30a and 30b, and the movable portion 13 may be formed of quartz plates, and the grooves 12a and 12b in the joint portion 12 may be formed from both surfaces of the quartz plate by half etching.

### 1-3. Functional Configuration of Sensor Module

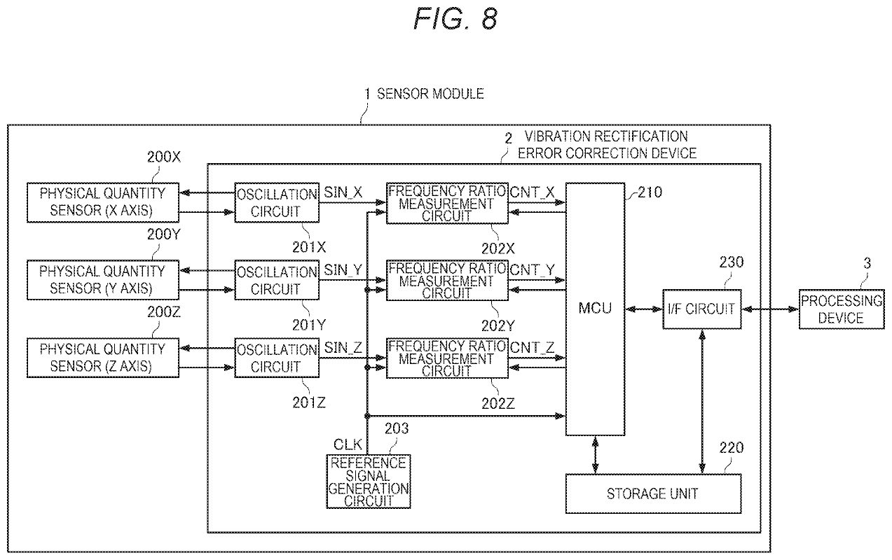

FIG. 8 is a functional block diagram of the sensor module 1. As described above, the sensor module 1 includes the physical quantity sensors 200X, 200Y, and 200Z and the vibration rectification error correction device 2.

The vibration rectification error correction device 2 includes oscillation circuits 201X, 201Y, and 201Z, frequency ratio measurement circuits 202X, 202Y, and 202Z, a micro control unit 210, a storage unit 220, and an interface circuit 230.

The oscillation circuit 201X amplifies the output signal of the physical quantity sensor 200X to generate a drive signal, and applies the drive signal to the physical quantity sensor 200X. By the drive signal, the vibration beams 41a and 41b of the physical quantity sensor 200X vibrate at a frequency corresponding to the acceleration in the X-axis direction, and a signal of the frequency is output from the physical quantity sensor 200X. The oscillation circuit 201X outputs a measurement signal SIN_X that is a rectangular wave signal obtained by amplifying the output signal of the physical quantity sensor 200X, to the frequency ratio measurement circuit 202X. The measurement signal SIN_X is a signal based on the output signal of the physical quantity sensor 200X.

Similarly, the oscillation circuit 201Y amplifies the output signal of the physical quantity sensor 200Y to generate a drive signal, and applies the drive signal to the physical quantity sensor 200Y. By the drive signal, the vibration beams 41a and 41b of the physical quantity sensor 200Y vibrate at a frequency corresponding to the acceleration in the Y-axis direction, and a signal of the frequency is output from the physical quantity sensor 200Y. The oscillation circuit 201Y outputs a measurement signal SIN_Y that is a rectangular wave signal obtained by amplifying the output signal of the physical quantity sensor 200Y, to the frequency ratio measurement circuit 202Y. The measurement signal SIN_Y is a signal based on the output signal of the physical quantity sensor 200Y.

Similarly, the oscillation circuit 201Z amplifies the output signal of the physical quantity sensor 200Z to generate a drive signal, and applies the drive signal to the physical quantity sensor 200Z. By the drive signal, the vibration beams 41a and 41b of the physical quantity sensor 200Z vibrate at a frequency corresponding to the acceleration in the Z-axis direction, and a signal of the frequency is output from the physical quantity sensor 200Z. The oscillation circuit 201Z outputs a measurement signal SIN_Z that is a rectangular wave signal obtained by amplifying the output signal of the physical quantity sensor 200Z, to the frequency ratio measurement circuit 202Z. The measurement signal SIN_Z is a signal based on the output signal of the physical quantity sensor 200Z.

A reference signal generation circuit 203 generates and outputs a reference signal CLK having a constant frequency. In the embodiment, the frequency of the reference signal CLK is larger than the frequencies of the measurement signals SIN_X, SIN_Y, and SIN_Z. The reference signal CLK preferably has a high frequency accuracy, and the reference signal generation circuit 203 may be, for example, a temperature compensated crystal oscillator, or may be implemented by a temperature compensated crystal oscillator and a PLL circuit that multiplies a frequency of an output signal thereof.

The frequency ratio measurement circuit 202X counts the number of pulses of the reference signal CLK included in a predetermined period of the measurement signal SIN_X, which is a signal based on the signal output from the oscillation circuit 201X, and outputs a count value CNT_X. The count value CNT_X is a reciprocal count value corresponding to a frequency ratio between the measurement signal SIN_X and the reference signal CLK.

The frequency ratio measurement circuit 202Y counts the number of pulses of the reference signal CLK in a predetermined period of the measurement signal SIN_Y output from the oscillation circuit 201Y, and outputs a count value CNT_Y. The count value CNT_Y is a reciprocal count value corresponding to a frequency ratio between the measurement signal SIN_Y and the reference signal CLK.

The frequency ratio measurement circuit 202Z counts the number of pulses of the reference signal CLK in a predetermined period of the measurement signal SIN_Z output from the oscillation circuit 201Z, and outputs a count value CNT_Z. The count value CNT_Z is a reciprocal count value corresponding to a frequency ratio between the measurement signal SIN_Z and the reference signal CLK.

The storage unit 220 stores programs and data, and may include a volatile memory such as an SRAM or a DRAM. The SRAM is an abbreviation for Static Random Access Memory, and the DRAM is an abbreviation for Dynamic Random Access Memory. The storage unit 220 may include a nonvolatile memory, such as a semiconductor memory such as an EEPROM or a flash memory, a magnetic storage device such as a hard disk device, or an optical storage device such as an optical disk device. The EEPROM is an abbreviation for Electrically Erasable Programmable Read Only Memory.

The micro control unit 210 operates in synchronization with the reference signal CLK, and executes a program (not illustrated) stored in the storage unit 220 to perform predetermined arithmetic processing and control processing. For example, the micro control unit 210 measures the physical quantities detected by the physical quantity sensors 200X, 200Y, and 200Z based on the count value CNT_X output from the frequency ratio measurement circuit 202X, the count value CNT_Y output from the frequency ratio measurement circuit 202Y, and the count value CNT_Z output from the frequency ratio measurement circuit 202Z, respectively. Specifically, the micro control unit 210 converts the count value CNT_X, the count value CNT_Y, and the count value CNT_Z into a measurement value of a physical quantity in the X-axis direction, a measurement value of a physical quantity in the Y-axis direction, and a measurement value of a physical quantity in the Z-axis direction, respectively. For example, table information for defining a correspondence relationship between the count value and the measurement value of the physical quantity or information on a relational expression between the count value and the measurement value of the physical quantity may be stored in the storage unit 220, and the micro control unit 210 may convert each count value into the measurement value of the physical quantity with reference to the information.

The micro control unit 210 may transmit the measurement value of the physical quantity in the X-axis direction, the measurement value of the physical quantity in the Y-axis direction, and the measurement value of the physical quantity in the Z-axis direction to a processing device 3 via the interface circuit 230. Alternatively, the micro control unit 210 may write the measurement value of the physical quantity in the X-axis direction, the measurement value of the physical quantity in the Y-axis direction, and the measurement value of the physical quantity in the Z-axis direction in the storage unit 220, and the processing device 3 may read each measurement value via the interface circuit 230.

Since the frequency ratio measurement circuits 202X, 202Y, and 202Z have the same configuration and operation, any one of the frequency ratio measurement circuits 202X, 202Y, and 202Z is hereinafter referred to as a frequency ratio measurement circuit 202. Any one of the measurement signals SIN_X, SIN_Y, and SIN_Z input to the frequency ratio measurement circuit 202 is referred to as a measurement signal SIN, and any one of the count values CNT_X, CNT_Y, and CNT_Z output from the frequency ratio measurement circuit 202 is referred to as a count value CNT.

### 1-4. Vibration Rectification Error

A vibration rectification error corresponds to a DC offset generated at the time of rectification due to non-linearity of a response of the sensor module 1 to the vibration, and is observed as an abnormal shift of an output offset of the sensor module 1. In an application in which a DC output of the sensor module 1 is a measurement target as it is, such as an inclinometer using the sensor module 1, the vibration rectification error is a serious measurement error. Main mechanisms that cause the vibration rectification error are: [1] asymmetrical rails, [2] non-linearity of scale factors, and [3] structural resonance of the physical quantity sensor 200.

### [1] Vibration Rectification Error Caused by Asymmetric Rails

When a sensitivity axis of the physical quantity sensor 200 is in a gravitational acceleration direction, an offset corresponding to a gravitational acceleration of 1 g=9.8 m/s² occurs in a measurement value of the sensor module 1. For example, when a dynamic range of the physical quantity sensor 200 is 2 g, vibrations that can be measured without clipping are up to 1 g. When a vibration exceeding 1 g is applied in this state, clipping occurs asymmetrically, and therefore, the vibration rectification error is included in the measurement value.

For example, when the dynamic range is as wide as 15 g, clipping is rarely a problem under normal usage conditions. Meanwhile, the physical quantity sensor 200 incorporates a physical protection mechanism for a purpose of preventing damage to the physical quantity detection element 40, and when a vibration level exceeds a certain threshold, the protection mechanism works, and thus clipping occurs. To prevent the occurrence of clipping, it is necessary to devise an attachment for providing the sensor module 1 and take measures such as damping a vibration in a resonance frequency band.

### [2] Vibration Rectification Error Caused by Non-Linearity of Scale Factors

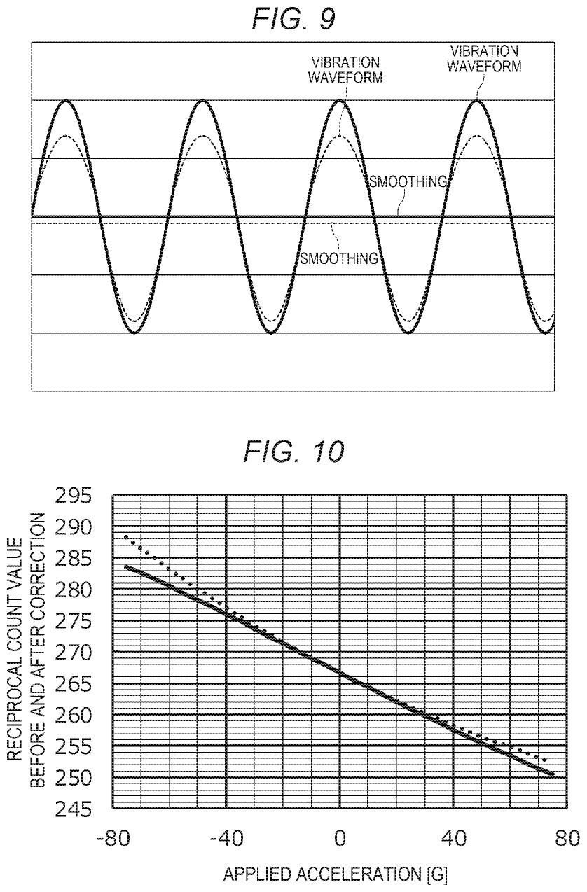

FIG. 9 is a diagram illustrating in principle that the vibration rectification error occurs due to an output waveform distortion. In FIG. 9, a solid line indicates a sinusoidal vibration waveform and a waveform obtained by smoothing the vibration waveform, and a broken line indicates a vibration waveform asymmetric above and below a vibration center and a waveform obtained by smoothing the vibration waveform. While the smoothed waveform indicated by the solid line is 0, the smoothed waveform indicated by the broken line is a negative value, and an offset occurs during smoothing.

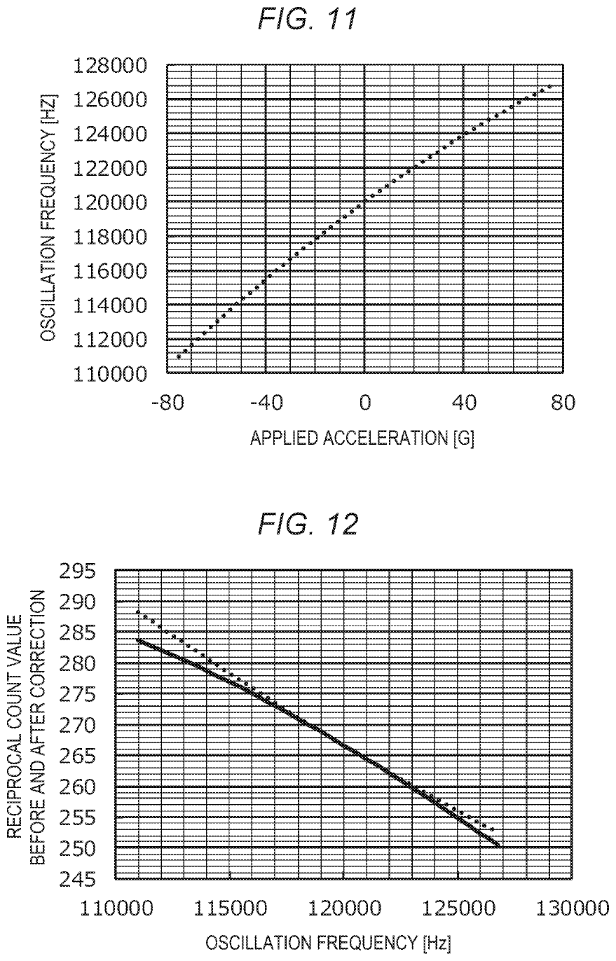

The physical quantity sensor 200 is a frequency-change type sensor, and the count value CNT corresponding to a frequency ratio between the measurement signal SIN and the reference signal CLK is a reciprocal count value. A relationship between the acceleration applied to the physical quantity sensor 200 and the reciprocal count value has non-linearity. A broken line in FIG. 10 indicates non-linearity between the applied acceleration and the reciprocal count value. A broken line in FIG. 11 indicates non-linearity between the applied acceleration and an oscillation frequency of the physical quantity sensor 200. A broken line in FIG. 12 indicates non-linearity between the oscillation frequency of the physical quantity sensor 200 and the reciprocal count value. The broken line in FIG. 10 is obtained by combining the broken line in FIG. 11 and the broken line in FIG. 12.

Here, by correcting the relationship between the oscillation frequency and the reciprocal count value as indicated by the solid line in FIG. 12, the relationship between the acceleration and the reciprocal count value can be approximated to a linear shape as indicated by the solid line in FIG. 10. Specifically, the micro control unit 210 described above can correct the count value CNT using a correction function represented by Equation (1).

$$Y = {\{ c - d \}}^{2} \qquad ( 1 )$$

In Equation (1), c is a count value before correction corresponding to the broken line in FIG. 10, Y is a count value after correction corresponding to the solid line in FIG. 10, and d is a coefficient for determining a degree of correction illustrated in FIG. 12. For example, the coefficient d is stored in the storage unit 220 or set by the processing device 3.

### [3] Vibration Rectification Error Caused by Cantilever Resonance

The physical quantity sensor 200 changes a tension acting on the physical quantity detection element 40 by transmitting a deflection of a cantilever with a weight due to the acceleration to the physical quantity detection element 40, which is a double-ended tuning fork vibrator, as a detection principle of the acceleration, thereby changing the oscillation frequency. Therefore, the physical quantity detection element 40 has a resonance frequency due to a structure of the cantilever, and when a cantilever resonance is excited, a unique vibration rectification error occurs. The cantilever resonance is a frequency larger than a frequency band corresponding to a detectable acceleration range, and a vibration component thereof is removed by a low-pass filter inside the vibration rectification error correction device 2, but a vibration rectification error occurs as a bias offset reflecting asymmetry of the vibration. As an amplitude of the cantilever resonance increases, asymmetry of an output waveform of the physical quantity sensor 200 increases, and thus the vibration rectification error also increases. Therefore, it is important to reduce the vibration rectification error caused by the cantilever resonance.

In the embodiment, since the frequency ratio measurement circuit 202 uses a reciprocal count method of counting the number of pulses of the reference signal CLK included in a predetermined period of the measurement signal SIN, a timing of acquiring the count value is synchronized with the measurement signal SIN. In contrast, the count value CNT output from the frequency ratio measurement circuit 202 needs to be synchronized with a frequency-divided signal of the reference signal CLK, and resampling is required because the timing of acquiring the count value of the number of pulses of the reference signal CLK is not synchronized with a frequency-divided signal of the reference signal CLK. In the frequency ratio measurement circuit 202, by devising a configuration necessary for resampling, it is possible to generate the count value CNT in which the vibration rectification error caused by the cantilever resonance is corrected.

### 1-5. Configuration of Frequency Ratio Measurement Circuit

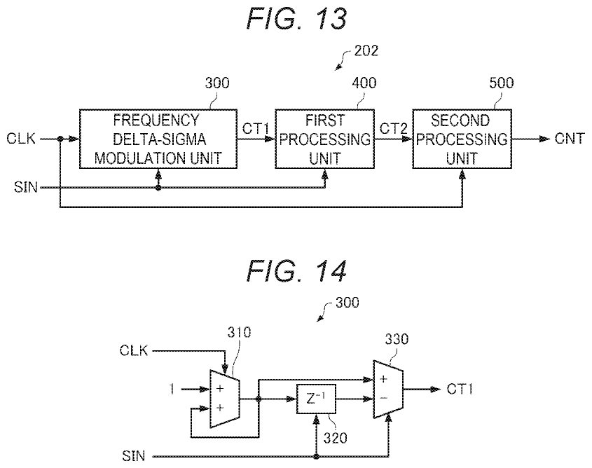

The frequency ratio measurement circuit 202 measures the frequency ratio between the measurement signal SIN and the reference signal CLK with the reciprocal count method. FIG. 13 is a diagram illustrating a configuration example of the frequency ratio measurement circuit 202. As illustrated in FIG. 13, the frequency ratio measurement circuit 202 includes a frequency delta-sigma modulation unit 300, a first processing unit 400, and a second processing unit 500.

The frequency delta-sigma modulation unit 300 performs frequency delta-sigma modulation on the reference signal CLK using the input measurement signal SIN, and generates a count value CT1 that is a frequency delta-sigma modulation signal.

The first processing unit 400 operates in synchronization with the measurement signal SIN, performs processing of applying a first group delay amount and first filter processing on the count value CT1, which is a frequency delta-sigma modulation signal, and outputs a count value CT2.

The second processing unit 500 operates in synchronization with the reference signal CLK, performs processing of applying a second group delay amount and second filter processing on the count value CT2 independently of each other, and outputs the count value CNT. That is, the second processing unit 500 performs the processing of applying the second group delay amount on the count value CT2 before performing the second filter processing, or performs the processing of applying the second group delay amount on the count value CT2 after performing the second filter processing.

The first group delay amount and the second group delay amount are variable independently of each other. That is, the first group delay amount can be variably set without being affected by a setting of the second group delay amount, and the second group delay amount can be variably set without being affected by a setting of the first group delay amount.

FIG. 14 is a diagram illustrating a configuration example of the frequency delta-sigma modulation unit 300. As illustrated in FIG. 14, the frequency delta-sigma modulation unit 300 includes a counter 310, a delay element 320, and a differentiator 330.

The counter 310 counts the number of rising edges of the reference signal CLK and outputs a count value CT0. However, the counter 310 may count the number of falling edges of the reference signal CLK, or may count the number of both rising edges and falling edges of the reference signal CLK.

The delay element 320 outputs a count value obtained by delaying the count value CT0 in synchronization with both the rising edge and the falling edge of the measurement signal SIN. The number of taps of the delay element 320 is 1. For example, the delay element 320 is implemented by a D flip-flop.

The differentiator 330 subtracts a count value output from the delay element 320 from the count value CT0 in synchronization with both edges of the measurement signal SIN to generate and output the count value CT1. The count value CT1 is a frequency delta-sigma modulation signal generated by the frequency delta-sigma modulation unit 300.

The frequency delta-sigma modulation unit 300 is also called a first-order frequency delta-sigma modulator, and sequentially holds the count value of the number of pulses of the reference signal CLK with both edges of the measurement signal SIN as a trigger. Here, it has been described that the frequency delta-sigma modulation unit 300 operates in synchronization with both edges of the measurement signal SIN, but the frequency delta-sigma modulation unit 300 may operate in synchronization with the rising edge of the measurement signal SIN or may operate in synchronization with the falling edge of the measurement signal SIN. The differentiator 330 calculates a difference between the count value CT0 and the count value output from the delay element 320, thereby outputting an increment of the count value of the number of pulses of the reference signal CLK observed during a half-cycle transition of the measurement signal SIN without any dead period. When a frequency of the measurement signal SIN is f_{ch} and a frequency of the reference signal CLK is f_{clk}, the frequency ratio is f_{clk}/f_{ch}. The frequency delta-sigma modulation unit 300 outputs the frequency delta-sigma modulation signal representing the frequency ratio, as a digital signal string.

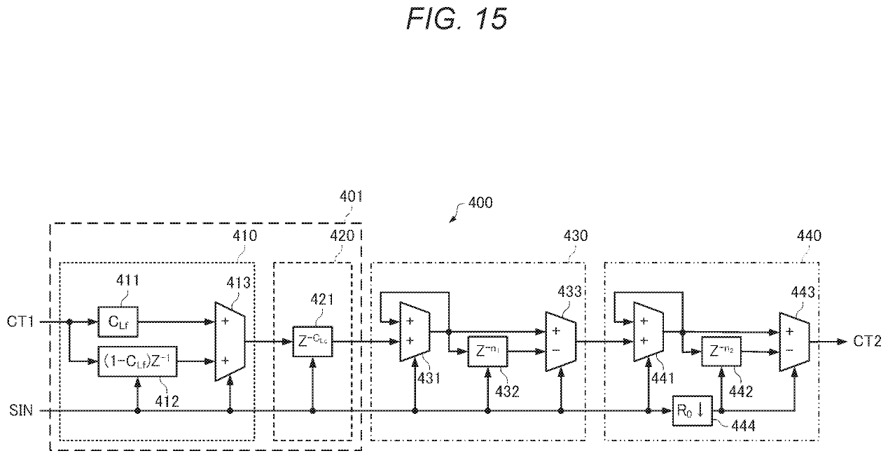

FIG. 15 is a diagram illustrating a configuration example of the first processing unit 400. As illustrated in FIG. 15, the first processing unit 400 includes a first group delay amount applying unit 401, a first low-pass filter 430, and a second low-pass filter 440.

The first group delay amount applying unit 401 is provided in a preceding stage of the first low-pass filter 430, and performs the processing of applying the first group delay amount on the count value CT1, which is the frequency delta-sigma modulation signal output from the frequency delta-sigma modulation unit 300. However, the first group delay amount applying unit 401 may be provided at a succeeding stage of the first low-pass filter 430. As illustrated in FIG. 15, the first group delay amount applying unit 401 includes a fine adjustment unit 410 and a coarse adjustment unit 420.

The fine adjustment unit 410 outputs a weighted average value of two signals based on the count value CT1 input at different timings in synchronization with the measurement signal SIN. In the example of FIG. 15, the fine adjustment unit 410 includes a multiplier 411, a delay element 412, and an adder 413.

The multiplier 411 outputs a count value obtained by multiplying the count value CT1 by C_{Lf}. 0<C_{Lf}<1. The delay element 412 is a delay element with a multiplication function, delays the count value CT0 in synchronization with both edges of the measurement signal SIN, and outputs a count value multiplied by (1−C_{Lf}). The number of taps of the delay element 412 is 1. For example, the delay element 412 is implemented by a D flip-flop and a multiplier. The adder 413 outputs a count value obtained by adding a count value output from the multiplier 411 and a count value output from the delay element 412 in synchronization with both edges of the measurement signal SIN.

The fine adjustment unit 410 implemented in this way outputs a weighted average value given by a ratio of C_{Lf} to (1−C_{Lf}) with respect to two consecutive count values CT1. In other words, the fine adjustment unit 410 outputs a count value obtained by internally dividing two consecutive count values CT1 by the ratio of C_{Lf} to (1−C_{Lf}), and this corresponds to outputting, to the count value CT1, a count value obtained by applying a group delay amount of (1−C_{Lf})/2f_{ch} shorter than ½f_{ch} which is a half period of the measurement signal SIN. For example, when C_{Lf} is 0.5, the count value output from the fine adjustment unit 410 is an average value of the current count value CT1 and the previous count value CT0, which corresponds to a count value obtained by applying a group delay amount of a time of ¼ periods of the measurement signal SIN to the count value CT0.

The coarse adjustment unit 420 is provided at a succeeding stage of the fine adjustment unit 410, and delays the weighted average value, which is the input signal, in synchronization with the measurement signal SIN. However, the coarse adjustment unit 420 may be provided in a preceding stage of the fine adjustment unit 410. In the example of FIG. 15, the coarse adjustment unit 420 includes a delay element 421. The delay element 421 outputs a count value obtained by delaying the count value output from the fine adjustment unit 410 in synchronization with both edges of the measurement signal SIN. For example, the delay element 421 is implemented by a shift register in which C_{Lc} D flip-flops are serially coupled.

The coarse adjustment unit 420 configured in this way outputs a count value obtained by applying the group delay amount of C_{Lc}/2f_{ch} to the count value output from the fine adjustment unit 410. Therefore, the first group delay amount added to the count value CT1 by the first group delay amount applying unit 401 is (1−C_{Lf})/2f_{ch}+C_{Lc}/2f_{ch}.

The first low-pass filter 430 performs low-pass filter processing as at least a part of the first filter processing described above. Specifically, the first low-pass filter 430 operates in synchronization with the measurement signal SIN, and outputs a count value obtained by removing or reducing a noise component included in the count value output from the first group delay amount applying unit 401. In the example of FIG. 15, the first low-pass filter 430 includes an integrator 431, a delay element 432, and a differentiator 433.

The integrator 431 outputs a count value obtained by integrating the count values output from the first group delay amount applying unit 401 in synchronization with both edges of the measurement signal SIN. The delay element 432 outputs a count value obtained by delaying the count value output from the integrator 431 in synchronization with both edges of the measurement signal SIN. The number of taps of the delay element 432 is n₁. For example, the delay element 432 is implemented by a shift register in which n₁ registers are serially coupled. The differentiator 433 outputs a count value obtained by subtracting the count value output from the delay element 432 from the count value output from the integrator 431 in synchronization with both edges of the measurement signal SIN.

The first low-pass filter 430 implemented in this way is a moving average filter having the number of taps of n₁, and a group delay time thereof is (n₁−1)/4f_{ch}.

The second low-pass filter 440 is provided at a succeeding stage of the first low-pass filter 430, and performs the low-pass filter processing and decimation processing as a part of the first filter processing described above. Specifically, the second low-pass filter 440 operates in synchronization with the measurement signal SIN, and outputs a count value obtained by removing or reducing a noise component included in the count value output from the first low-pass filter 430. However, when the first group delay amount applying unit 401 is provided at the succeeding stage of the first low-pass filter 430, the second low-pass filter 440 outputs a count value obtained by removing or reducing a noise component included in the count value output from the first group delay amount applying unit 401. In the example of FIG. 15, the second low-pass filter 440 includes an integrator 441, a delay element 442, a differentiator 443, and a decimator 444.

The integrator 441 outputs a count value obtained by integrating the count values output from the first low-pass filter 430 in synchronization with both edges of the measurement signal SIN. The decimator 444 outputs a signal obtained by decimating a rate of the measurement signal SIN to 1/R₀. That is, the signal output from the decimator 444 is a signal obtained by dividing the measurement signal SIN by R₀. The delay element 442 outputs a count value obtained by delaying the count value output from the integrator 441 in synchronization with both edges of the signal output from the decimator 444. The number of taps of the delay element 442 is n₂. For example, the delay element 442 is implemented by a shift register in which n₂ registers are serially coupled. The differentiator 443 outputs the count value CT2 obtained by subtracting the count value output from the delay element 442 from the count value output from the integrator 441 in synchronization with both edges of the signal output from the decimator 444.

The second low-pass filter 440 implemented in this way is a moving average filter having an effective number of taps of n₂R₀, and a group delay time thereof is (n₂R₀−1)/4f_{ch}.

FIG. 16 is a diagram illustrating a configuration example of the second processing unit 500. As illustrated in FIG. 16, the second processing unit 500 includes a second group delay amount applying unit 510 and a third low-pass filter 520.

The second group delay amount applying unit 510 is provided in a preceding stage of the third low-pass filter 520, and performs the processing of applying the second group delay amount on the count value CT2 output from the first processing unit 400. However, the second group delay amount applying unit 510 may be provided at a succeeding stage of the third low-pass filter 520. As illustrated in FIG. 16, the second group delay amount applying unit 510 includes a delay element 511 and a decimator 512.

The decimator 512 outputs a signal obtained by decimating a rate of the reference signal CLK to 1/R₁. That is, the signal output from the decimator 512 is a signal obtained by dividing the reference signal CLK by R₁. The delay element 511 outputs a count value obtained by delaying the count value CT2 output from the first processing unit 400 in synchronization with a rising edge of the signal output from the decimator 512. The number of taps of the delay element 511 is S_{ync}. For example, the delay element 511 is implemented by a shift register in which S_{ync} registers are serially coupled.

A group delay time of the second group delay amount applying unit 510 implemented in this way is S_{ync}R₁/f_{clk}. That is, the second group delay amount added to the count value CT2 by the second group delay amount applying unit 510 is S_{ync}R₁/f_{clk}.

The third low-pass filter 520 performs at least a part of the second filter processing described above. In the embodiment, the third low-pass filter 520 performs the low-pass filter processing and the decimation processing. Specifically, the third low-pass filter 520 operates in synchronization with the reference signal CLK, and outputs a count value obtained by removing or reducing a noise component included in the count value output from the second group delay amount applying unit 510. However, when the second group delay amount applying unit 510 is provided at the succeeding stage of the third low-pass filter 520, the third low-pass filter 520 outputs a count value obtained by removing or reducing a noise component included in the count value CT2 output from the first processing unit 400. In the example of FIG. 16, the third low-pass filter 520 includes an integrator 521, a delay element 522, a differentiator 523, and a decimator 524.

The integrator 521 outputs a count value obtained by integrating the count values output from the second group delay amount applying unit 510 in synchronization with the rising edge of the reference signal CLK. The decimator 524 outputs a signal obtained by decimating the rate of the reference signal CLK to 1/R₂. That is, a signal output from the decimator 524 is a signal obtained by dividing the reference signal CLK by R₂. The delay element 522 outputs a count value obtained by delaying the count value output from the integrator 521 in synchronization with a rising edge of the signal output from the decimator 524. The number of taps of the delay element 522 is n₃. For example, the delay element 522 is implemented by a shift register in which n₃ registers are serially coupled. The differentiator 523 outputs the count value CNT obtained by subtracting the count value output from the delay element 522 from the count value output from the integrator 521 in synchronization with the rising edge of the signal output from the decimator 524.

The third low-pass filter 520 implemented in this way is a moving average filter having an effective number of taps of n₃R₂, and a group delay time thereof is (n₃R₂−1)/2f_{clk}.

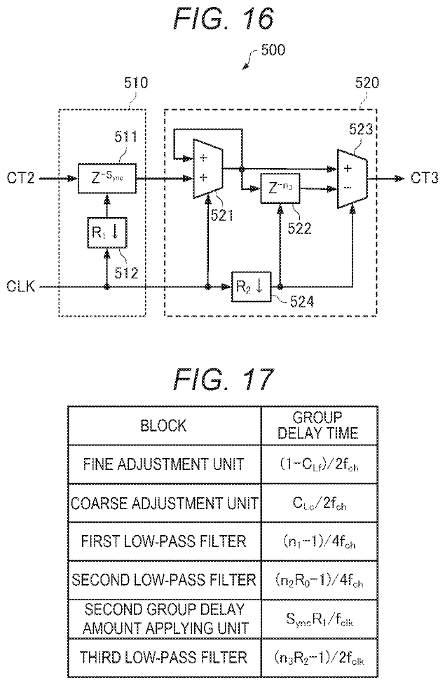

FIG. 17 is a table illustrating a relationship between each block of the frequency ratio measurement circuit 202 and the group delay time. A total group delay time that is a group delay time from when the measurement signal SIN is input to when the count value CNT is output is calculated as a sum of the group delay times of the blocks, and is (1−C_{Lf})/2f_{ch}+C_{Lc}/2f_{ch}+(n₁−1)/4f_{ch}+(n₂R₀−1)/4f_{ch}+S_{ync}R₁/f_{clk}+(n₃R₂−1)/2f_{clk}. Therefore, the total group delay time is determined by the frequency f_{ch} of the measurement signal SIN, the frequency f_{clk} of the reference signal CLK, the number of taps n₁, n₂, n₃, C_{Lc}, and S_{ync}, the multiplier C_{Lf}, and the decimation ratios R₀, R₁, and R₂. The frequency f_{clk} is substantially constant, and the frequency f_{ch} changes according to the physical quantity detected by the physical quantity sensor 200. For example, the number of taps n₁, n₂, and n₃ and the decimation ratios R₀, R₁, and R₂ are fixed, and the multiplier C_{Lf}, the number of taps C_{Lc}, and the number of taps S_{ync} are variable independently of each other. That is, the first group delay amount (1−C_{Lf})/2f_{ch}+C_{Lc}/2f_{ch} and the second group delay amount S_{ync}R₁/f_{clk} can be variably set independently of each other.

Here, the first low-pass filter 430 and the second low-pass filter 440 operate in synchronization with the measurement signal SIN, whereas the third low-pass filter 520 operates in synchronization with the reference signal CLK. Therefore, the third low-pass filter 520 executes integration processing while resampling the count value CT2 updated in synchronization with the measurement signal SIN at high speed in synchronization with the reference signal CLK. In the third low-pass filter 520, since the number of times of integration increases as the period of the measurement signal SIN becomes longer and the number of times of integration decreases as the period of the measurement signal SIN becomes shorter, it can be seen that weighted average processing according to the period of the measurement signal SIN is performed on the count value CT2.

When the period of the measurement signal SIN becomes longer, both the count value CT1 and a weight thereof become larger, and when the period of the measurement signal SIN becomes shorter, both the count value CT1 and the weight thereof become smaller. When a cantilever of the physical quantity sensor 200 is in a resonant state, since the period of the measurement signal SIN is modulated by the resonance frequency of the cantilever, a magnitude of the weight changes regularly, and the vibration rectification error becomes significant. Since the first group delay amount applying unit 401 adds the first group delay amount to the count value CT1 to temporally shift the weight with respect to the count value CT1 at the time of resonance of the cantilever, a value of the vibration rectification error also changes. Therefore, it is possible to reduce the vibration rectification error accompanying the resonance of the cantilever by appropriately adjusting the first group delay amount.

Meanwhile, a frequency and sensitivity of the physical quantity detection element 40 provided in the physical quantity sensor 200 change depending on a manufacturing error of the physical quantity sensor 200, a position and an orientation at which the physical quantity sensor 200 is fixed to the sensor module 1, and the like. Therefore, the frequency and the sensitivity of the physical quantity detection element 40 provided in each of the physical quantity sensors 200X, 200Y, and 200Z vary. As a result, a difference occurs in the total group delay time of each of the frequency ratio measurement circuits 202X, 202Y, and 202Z, and a time shift occurs between the measurement value of the acceleration in the X-axis direction, the measurement value of the acceleration in the Y-axis direction, and the measurement value of the acceleration in the Z-axis direction. By adjusting the second group delay amount in each of the frequency ratio measurement circuits 202X, 202Y, and 202Z, it is possible to make the total group delay time uniform and reduce the time shift of the measurement value. In other words, the second group delay amount of each of the frequency ratio measurement circuits 202X, 202Y, and 202Z is set such that the group delay times of the frequency ratio measurement circuits 202X, 202Y, and 202Z coincide with each other, that is, are substantially equal to each other.

The second group delay amount can be adjusted with a resolution of R₁ times the period of the reference signal CLK. Therefore, in consideration of a maximum value and a minimum value of the variation in the total group delay time among the frequency ratio measurement circuits 202X, 202Y, and 202Z, the decimation ratio R₁ is fixed to an appropriate value to obtain a resolution necessary for setting the difference in the total group delay time to a desired value or less. For example, when the frequency of the reference signal CLK is 50 MHz and the resolution required for adjustment is 1 μsec, the decimation ratio R₁ is fixed to 50.

The first low-pass filter 430 is an example of a “first filter”, the second low-pass filter 440 is an example of a “second filter”, and the third low-pass filter 520 is an example of a “third filter”. The count value CT2 is an example of a “first signal”, and the count value CNT is an example of a “second signal”.

### 1-6. Advantageous Effects

As described above, in the sensor module 1 according to the first embodiment, in each of the plurality of frequency ratio measurement circuits 202 provided in the vibration rectification error correction device 2, since the first processing unit 400 operates in synchronization with the measurement signal SIN and the second processing unit 500 operates in synchronization with the reference signal CLK different from the measurement signal SIN, non-linearity occurs in the relationship between the count value CT1 output from the frequency delta-sigma modulation unit 300 and the count value CNT output from the second processing unit 500. Therefore, it is possible to correct the vibration rectification error by setting the first group delay amount to an appropriate value in each of the plurality of frequency ratio measurement circuits 202.

By adjusting the second group delay amount in each of the plurality of frequency ratio measurement circuits 202, it is possible to adjust the total group delay time from when the measurement signal SIN is input to when the count value CNT is output. In each of the plurality of frequency ratio measurement circuits 202, since the first group delay amount and the second group delay amount are variable independently of each other, it is possible to adjust the second group delay amount without affecting the correction of the vibration rectification error.

That is, in each of the plurality of frequency ratio measurement circuits 202, the correction of the vibration rectification error and the adjustment of the total group delay time can be independently performed. Since the second group delay amount of each of the plurality of frequency ratio measurement circuits 202 is set such that the total group delay times coincide with each other among the plurality of frequency ratio measurement circuits 202, there is almost no difference in an acquisition timing of the count value CNT based on the output signal of each of the plurality of physical quantity sensors 200.

### 2. Second Embodiment

Hereinafter, in a sensor module according to a second embodiment, the same elements as those in the first embodiment will be denoted by the same reference numerals, the description overlapping with the first embodiment will be omitted or simplified, and contents different from those in the first embodiment will be mainly described.

Since a structure of the sensor module 1 according to the second embodiment is the same as that of the first embodiment, illustration and description thereof will be omitted.

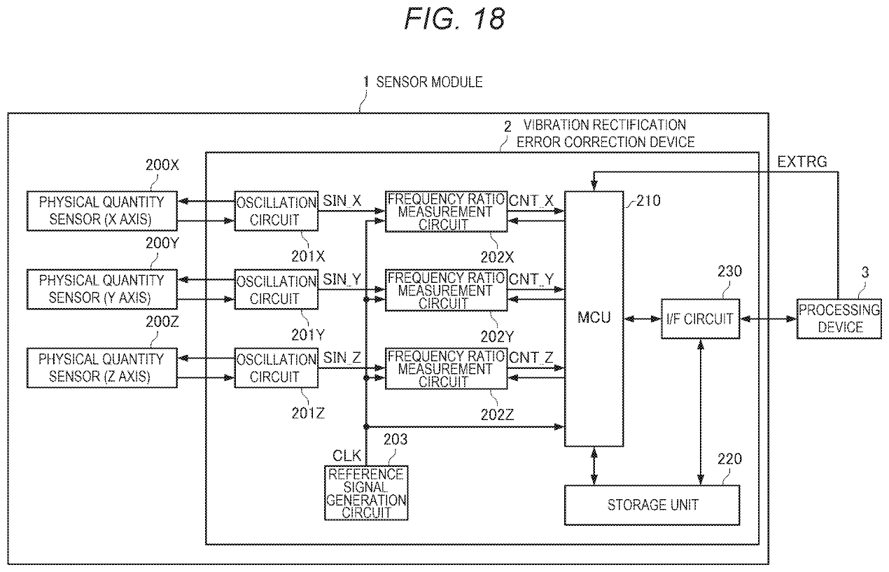

FIG. 18 is a functional block diagram of the sensor module 1 according to the second embodiment. As illustrated in FIG. 18, an external trigger signal EXTRG for requesting acquisition of the count values CNT_X, CNT_Y, and CNT_Z is input to the micro control unit 210 from an outside of the sensor module 1. The external trigger signal EXTRG is output from, for example, the processing device 3 outside the sensor module 1.

For example, the micro control unit 210 acquires the count value CNT_X output from the frequency ratio measurement circuit 202X, the count value CNT_Y output from the frequency ratio measurement circuit 202Y, and the count value CNT_Z output from the frequency ratio measurement circuit 202Z at the timing when the external trigger signal EXTRG is input, and measures physical quantities detected by the physical quantity sensors 200X, 200Y, and 200Z based on the count values CNT_X, CNT_Y, and CNT_Z. Specifically, the micro control unit 210 converts the count values CNT_X, CNT_Y, and CNT_Z into a measurement value of a physical quantity in the X-axis direction, a measurement value of a physical quantity in the Y-axis direction, and a measurement value of a physical quantity in the Z-axis direction, respectively. For example, table information for defining a correspondence relationship between the count value and the measurement value of the physical quantity or information on a relational expression between the count value and the measurement value of the physical quantity may be stored in the storage unit 220, and the micro control unit 210 may convert each count value into the measurement value of the physical quantity with reference to the information.

The micro control unit 210 may transmit the measurement value of the physical quantity in the X-axis direction, the measurement value of the physical quantity in the Y-axis direction, and the measurement value of the physical quantity in the Z-axis direction to the processing device 3 via the interface circuit 230. Alternatively, the micro control unit 210 may write the measurement value of the physical quantity in the X-axis direction, the measurement value of the physical quantity in the Y-axis direction, and the measurement value of the physical quantity in the Z-axis direction in the storage unit 220, respectively, and the processing device 3 may read each measurement value via the interface circuit 230.

Here, since the external trigger signal EXTRG is a signal requesting the acquisition of the count values CNT_X, CNT_Y, and CNT_Z, it is preferable that a timing when the count values CNT_X, CNT_Y, and CNT_Z are updated coincides with a timing when the external trigger signal EXTRG is input. Therefore, in the second embodiment, in the frequency ratio measurement circuits 202X, 202Y, and 202Z, a first group delay amount and a second group delay amount are set such that the timing when the external trigger signal EXTRG is input and the timing when the count values CNT_X, CNT_Y, and CNT_Z are updated coincide with each other, that is, are substantially equal to each other.

For example, when a period in which the external trigger signal EXTRG is input is 250 μsec and a total group delay time of the frequency ratio measurement circuits 202X, 202Y, and 202Z is 1130 μsec, the count values CNT_X, CNT_Y, and CNT_Z are updated every time at a timing shifted from the timing when the external trigger signal EXTRG is input by 1130 μsec-250 μsec×4=130 μsec. Therefore, to eliminate this timing shift, for example, the first group delay amount and the second group delay amount are set such that the total group delay time of the frequency ratio measurement circuits 202X, 202Y, and 202Z is 1250 μsec=250 μsec×5.

Since the other configurations of the sensor module 1 according to the second embodiment are the same as those of the first embodiment, the description thereof will be omitted.

According to the sensor module 1 of the second embodiment described above, the same effects as those of the sensor module 1 according to the first embodiment can be obtained. According to the sensor module 1 of the second embodiment, in the vibration rectification error correction device 2, it is possible to acquire appropriate count values CNT_X, CNT_Y, and CNT_Z at the timing when the external trigger signal EXTRG is input.

### 3. Modification

The present disclosure is not limited to the embodiments, and various modifications can be implemented within the scope of the gist of the present disclosure.

For example, in each of the embodiments described above, the sensor module 1 includes three physical quantity sensors 200, but the number of physical quantity sensors 200 provided in the sensor module 1 may be one, two, or four or more. When the sensor module 1 includes a plurality of physical quantity sensors 200, the vibration rectification error correction device 2 includes the reference signal generation circuit 203 that outputs the reference signal CLK and the plurality of frequency ratio measurement circuits 202, and the plurality of measurement signals SIN based on the output signals of the plurality of physical quantity sensors 200 are input to the plurality of frequency ratio measurement circuits 202, respectively. Each of the plurality of frequency ratio measurement circuits 202 includes the frequency delta-sigma modulation unit 300, the first processing unit 400, and the second processing unit 500 similarly to each of the embodiments described above, and the first group delay amount and the second group delay amount are independently variable. The first group delay amount and the second group delay amount of each of the plurality of frequency ratio measurement circuits 202 are set such that the total group delay times coincide with each other among the plurality of frequency ratio measurement circuits 202, that is, the total group delay times are substantially equal to each other.

For example, the sensor module 1 may include two physical quantity sensors 200A and 200B whose detection axes are opposite to each other, a frequency ratio measurement circuit 202A may output a count value CNT_A based on a measurement signal SIN_A obtained by amplifying an output signal of the physical quantity sensor 200A, and a frequency ratio measurement circuit 202B may output a count value CNT_B based on a measurement signal SIN_B obtained by amplifying an output signal of the physical quantity sensor 200B. The micro control unit 210 can reduce an in-phase noise included in the count values CNT_A and CNT_B and double measurement sensitivity by calculating a measurement value of a physical quantity based on a difference between the count value CNT_A and the count value CNT_B. Also in such a sensor module 1, a first group delay amount and a second group delay amount of each of the frequency ratio measurement circuits 202A and 202B are set such that total group delay times coincide with each other between the frequency ratio measurement circuits 202A and 202B, that is, the total group delay times are substantially equal to each other.

In the embodiments described above, the sensor module 1 including the acceleration sensor is exemplified as the physical quantity sensor 200, but the sensor module 1 may include sensors such as an angular velocity sensor, a pressure sensor, or an optical sensor as the physical quantity sensor 200. The sensor module 1 may include two or more types of physical quantity sensors among various physical quantity sensors such as an acceleration sensor, an angular velocity sensor, a pressure sensor, and an optical sensor.

In the embodiments described above, an element configured using quartz crystal is exemplified as the physical quantity detection element 40 provided in the physical quantity sensor 200, but the physical quantity detection element 40 may be implemented using a piezoelectric element other than quartz crystal, or may be a capacitive MEMS element. MEMS is an abbreviation for Micro Electro Mechanical Systems.

In the embodiments described above, the first low-pass filter 430 is exemplified as the first filter, the second low-pass filter 440 is exemplified as the second filter, and the third low-pass filter 520 is exemplified as the third filter, but the first filter, the second filter, and the third filter may be a high-pass filter, a bandpass filter, or a smoothing filter. That is, the filter processing of each of the first filter, the second filter, and the third filter may be high-pass filter processing, bandpass filter processing, or smoothing filter processing in addition to the low-pass filter processing.

### 4. Application Example

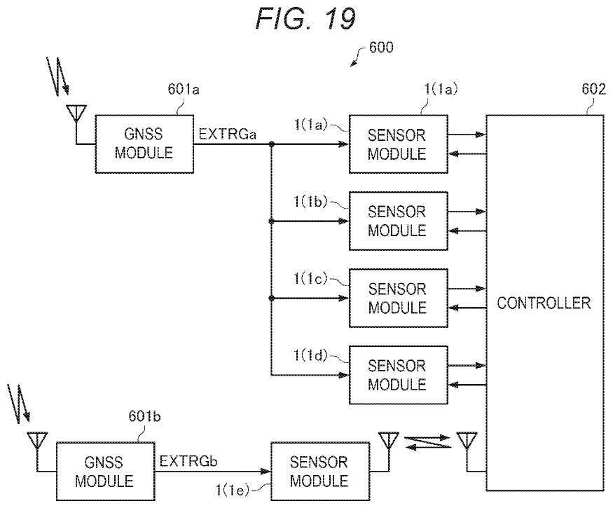

A sensing system can be constructed by using a plurality of sensor modules 1 according to the embodiments described above. FIG. 19 is a diagram illustrating a configuration example of a sensing system. A sensing system 600 illustrated in FIG. 19 includes sensor modules 1a, 1b, 1c, 1d, and 1e, GNSS modules 601a and 601b, and a controller 602.

The GNSS module 601a receives a GNSS signal, and generates and outputs an external trigger signal EXTRGa in synchronization with the GNSS signal. Similarly, the GNSS module 601b receives the GNSS signal, and generates and outputs an external trigger signal EXTRGb in synchronization with the GNSS signal. The external trigger signals EXTRGa and EXTRGb may be, for example, 1 PPS signals.

Each of the sensor modules 1a, 1b, 1c, and 1d is, for example, the sensor module 1 illustrated in FIG. 18, and the external trigger signal EXTRGa is input thereto. Similarly, the sensor module 1e is, for example, the sensor module 1 illustrated in FIG. 18, and the external trigger signal EXTRGb is input thereto.

The controller 602 controls on and off of the sensor modules 1a, 1b, 1c, 1d, and 1e, acquires measurement values of the sensor modules 1a, 1b, 1c, 1d, and 1e, and performs various calculations. The controller 602 may set a first group delay amount and a second group delay amount for each of the sensor modules 1a, 1b, 1c, 1d, and 1e, or may set a filter coefficient or the like. The controller 602 may be coupled to each of the sensor modules 1a, 1b, 1c, 1d, and 1e by wire or wirelessly.

In the sensor modules 1a, 1b, 1c, 1d, and 1e, since the influence of gravity changes depending on a provision posture, a resonance frequency is offset for each physical quantity detection element 40, and a total group delay time changes. After the sensor modules 1a, 1b, 1c, 1d, and 1e are provided, a frequency of each physical quantity detection element 40 is measured, and based on the measured frequency, the first group delay amount and the second group delay amount are set such that the total group delay times coincide with each other.

According to the sensing system 600, since the synchronization of the sensor modules 1a, 1b, 1c, 1d, and 1e is established, calculation accuracy of the controller 602 is improved.

The above-described embodiments and modifications are merely examples, and the present disclosure is not limited thereto. For example, the embodiments and the modifications may be combined as appropriate.

The present disclosure has substantially the same configurations as the configurations described in the embodiments, such as configurations having the same functions, methods, and results, or configurations having the same objects and advantages. The present disclosure has a configuration in which a non-essential portion of the configuration described in the embodiments is replaced. The present disclosure has configurations that exert the same advantageous effects or configurations that can achieve the same objects as those of the configurations described in the embodiments. The present disclosure has a configuration obtained by adding a publicly-known technique to the configuration described in the embodiments.

The following contents can be derived from the above-described embodiments and modifications.

A vibration rectification error correction device according to one aspect includes:
a reference signal generation circuit configured to output a reference signal;
a frequency delta-sigma modulation unit configured to perform frequency delta-sigma modulation on the reference signal using a measurement signal to generate a frequency delta-sigma modulation signal;
a first processing unit configured to operate in synchronization with the measurement signal, perform processing of applying a first group delay amount and first filter processing on the frequency delta-sigma modulation signal, and output a first signal; and
a second processing unit configured to operate in synchronization with the reference signal, perform processing of applying a second group delay amount and second filter processing on the first signal independently of each other, and output a second signal, in which
the first group delay amount and the second group delay amount are variable independently of each other.

In the vibration rectification error correction device, since the first processing unit operates in synchronization with the measurement signal and the second processing unit operates in synchronization with the reference signal, which is different from the measurement signal, non-linearity occurs in the relationship between the frequency delta-sigma modulation signal and the second signal. Therefore, according to the vibration rectification error correction device, it is possible to correct the vibration rectification error by setting the first group delay amount to an appropriate value. According to the vibration rectification error correction device, it is possible to adjust the group delay time from when the measurement signal is input to when the second signal is output by adjusting the second group delay amount. Since the first group delay amount and the second group delay amount are variable independently of each other, the second group delay amount can be adjusted without affecting the correction of the vibration rectification error. That is, according to the vibration rectification error correction device, it is possible to independently perform the correction of the vibration rectification error and the adjustment of the group delay time.

In the vibration rectification error correction device according to one aspect,
the first processing unit may include
   a first filter configured to perform low-pass filter processing as at least a part of the first filter processing, and
   a first group delay amount applying unit that is provided at a preceding stage or a succeeding stage of the first filter and is configured to perform the processing of applying the first group delay amount.

In the vibration rectification error correction device according to one aspect,
the first group delay amount applying unit may include
   a fine adjustment unit configured to output a weighted average value of two signals based on the frequency delta-sigma modulation signal, the two signals being input at different timings in synchronization with the measurement signal, and
   a coarse adjustment unit that is provided at a succeeding stage or a preceding stage of the fine adjustment unit and is configured to delay an input signal in synchronization with the measurement signal.

According to the vibration rectification error correction device, since the group delay amount less than the period of the measurement signal can be applied to the frequency delta-sigma modulation signal by the fine adjustment unit, the first group delay amount can be finely set.

In the vibration rectification error correction device according to one aspect,
the first processing unit may include
   a second filter that is provided at the succeeding stage of the first filter and is configured to perform the low-pass filter processing and decimation processing as a part of the first filter processing.

In the vibration rectification error correction device according to one aspect, the second processing unit may include
a third filter configured to perform at least a part of the second filter processing, and
a second group delay amount applying unit that is provided at a preceding stage or a succeeding stage of the third filter and is configured to perform the processing of applying the second group delay amount.

In the vibration rectification error correction device according to one aspect,
the third filter may perform low-pass filter processing and decimation processing.

In the vibration rectification error correction device according to one aspect,
the first group delay amount and the second group delay amount may be set such that a timing when an external trigger signal requesting acquisition of the second signal is input and a timing when the second signal is updated coincide with each other.

According to the vibration rectification error correction device, it is possible to acquire an appropriate second signal at the timing when the external trigger signal is input.

A sensor module according to one aspect includes:
a plurality of physical quantity sensors; and
a vibration rectification error correction device, in which
the vibration rectification error correction device includes
   a reference signal generation circuit configured to output a reference signal, and
   a plurality of frequency ratio measurement circuits,
a plurality of measurement signals based on output signals of the plurality of physical quantity sensors are input to the plurality of frequency ratio measurement circuits, respectively,
each of the plurality of frequency ratio measurement circuits includes
   a frequency delta-sigma modulation unit configured to perform frequency delta-sigma modulation on the reference signal using the input measurement signal to generate a frequency delta-sigma modulation signal,
   a first processing unit configured to operate in synchronization with the measurement signal, perform processing of applying a first group delay amount and first filter processing on the frequency delta-sigma modulation signal, and output a first signal, and
   a second processing unit configured to operate in synchronization with the reference signal, perform processing of applying a second group delay amount and second filter processing on the first signal independently of each other, and output a second signal,
the first group delay amount and the second group delay amount are variable independently of each other, and
the second group delay amount of each of the plurality of frequency ratio measurement circuits is set such that group delay times from when the measurement signal is input to when the second signal is output coincide with each other among the plurality of frequency ratio measurement circuits.

In the sensor module, in each of the plurality of frequency ratio measurement circuits provided in the vibration rectification error correction device, since the first processing unit operates in synchronization with the measurement signal and the second processing unit operates in synchronization with the reference signal, which is different from the measurement signal, non-linearity occurs in the relationship between the frequency delta-sigma modulation signal and the second signal. Therefore, it is possible to correct the vibration rectification error by setting the first group delay amount to an appropriate value in each of the plurality of frequency ratio measurement circuits. By adjusting the second group delay amount in each of the plurality of frequency ratio measurement circuits, it is possible to adjust the group delay time from when the measurement signal is input to when the second signal is output. In each of the plurality of frequency ratio measurement circuits, since the first group delay amount and the second group delay amount are variable independently of each other, it is possible to adjust the second group delay amount without affecting the correction of the vibration rectification error. That is, in each of the plurality of frequency ratio measurement circuits, the correction of the vibration rectification error and the adjustment of the group delay time can be independently performed. Since the second group delay amount of each of the plurality of frequency ratio measurement circuits is set such that the group delay times from when the measurement signal is input to when the second signal is output coincide with each other among the plurality of frequency ratio measurement circuits, there is almost no difference in the acquisition timing of the second signal based on the output signal of each of the plurality of physical quantity sensors.

What is claimed is:

1. A vibration rectification error correction device comprising:
a reference signal generation circuit configured to output a reference signal;
a frequency delta-sigma modulation unit configured to perform frequency delta-sigma modulation on the reference signal using a measurement signal to generate a frequency delta-sigma modulation signal;
a first processing unit configured to operate in synchronization with the measurement signal, perform processing of applying a first group delay amount and first filter processing on the frequency delta-sigma modulation signal, and output a first signal; and
a second processing unit configured to operate in synchronization with the reference signal, perform processing of applying a second group delay amount and second filter processing on the first signal independently of each other, and output a second signal, wherein
the first group delay amount and the second group delay amount are variable independently of each other.

2. The vibration rectification error correction device according to claim 1, wherein
the first processing unit includes
a first filter configured to perform low-pass filter processing as at least a part of the first filter processing, and
a first group delay amount applying unit that is provided at a preceding stage or a succeeding stage of the first filter and is configured to perform the processing of applying the first group delay amount.

3. The vibration rectification error correction device according to claim 2, wherein
the first group delay amount applying unit includes
a fine adjustment unit configured to output a weighted average value of two signals based on the frequency delta-sigma modulation signal, the two signals being input at different timings in synchronization with the measurement signal, and
a coarse adjustment unit that is provided at a succeeding stage or a preceding stage of the fine adjustment unit and is configured to delay an input signal in synchronization with the measurement signal.

4. The vibration rectification error correction device according to claim 2, wherein
the first processing unit includes
a second filter that is provided at the succeeding stage of the first filter and is configured to perform the low-pass filter processing and decimation processing as a part of the first filter processing.

5. The vibration rectification error correction device according to claim 1, wherein
the second processing unit includes
a third filter configured to perform at least a part of the second filter processing, and
a second group delay amount applying unit that is provided at a preceding stage or a succeeding stage of the third filter and is configured to perform the processing of applying the second group delay amount.

6. The vibration rectification error correction device according to claim 5, wherein
the third filter performs low-pass filter processing and decimation processing.

7. The vibration rectification error correction device according to claim 1, wherein
the first group delay amount and the second group delay amount are set such that a timing when an external trigger signal requesting acquisition of the second signal is input and a timing when the second signal is updated coincide with each other.

8. A sensor module comprising:
a plurality of physical quantity sensors; and
a vibration rectification error correction device, wherein
the vibration rectification error correction device includes
a reference signal generation circuit configured to output a reference signal, and
a plurality of frequency ratio measurement circuits,
a plurality of measurement signals based on output signals of the plurality of physical quantity sensors are input to the plurality of frequency ratio measurement circuits, respectively,
each of the plurality of frequency ratio measurement circuits includes
a frequency delta-sigma modulation unit configured to perform frequency delta-sigma modulation on the reference signal using the input measurement signal to generate a frequency delta-sigma modulation signal,
a first processing unit configured to operate in synchronization with the measurement signal, perform processing of applying a first group delay amount and first filter processing on the frequency delta-sigma modulation signal, and output a first signal, and
a second processing unit configured to operate in synchronization with the reference signal, perform processing of applying a second group delay amount and second filter processing on the first signal independently of each other, and output a second signal,
the first group delay amount and the second group delay amount are variable independently of each other, and
the second group delay amount of each of the plurality of frequency ratio measurement circuits is set such that group delay times from when the measurement signal is input to when the second signal is output coincide with each other among the plurality of frequency ratio measurement circuits.
